(19) United States
(12) Patent Application Publication
(10) Pub. No.: US 2010/0070358 A1
(43) Pub. Date: Mar. 18, 2010

(54) REC CREDIT DISTRIBUTION SYSTEM AND METHOD

(75) Inventors: Robert A. Olson, Hopkinton, NH (US); James W. Bohlig, Cuttingville, VT (US)

Correspondence Address: WILMERHALE/DC, 1875 PENNSYLVANIA AVE., NW, WASHINGTON, DC, 20006, US

(73) Assignee: Casella Waste Systems, Inc., Rutland, VT (US)

(21) Appl. No.: 12/561,091

(22) Filed: Sep. 16, 2009

Related U.S. Application Data
(63) Continuation of application No. 11/542,880, filed on Oct. 4, 2006, now abandoned.

(51) Int. Cl. G06Q 50/00; G06Q 30/00; G06Q 10/00; G06F 15/16

(52) U.S. Cl. 705/14.17; 705/14.31; 705/14.33; 705/14.34; 705/41; 705/308; 705/317; 709/206

(57) ABSTRACT

A method for promoting recycling from a fund established with revenue generated from the sale of environmental and/or power generation attributes by an entity producing renewable energy. The method comprises providing a point system by which a recycling consumer is credited for recycled materials collected. Further, the method provides for a reward system for redemption of points accumulated by the recycling consumer, the reward system including redeemable fund certificates drawn against the fund. The method further includes collecting recyclable materials from the recycling consumer and crediting an account in the name of the recycling consumer based on the quantity and/or quality of the recyclable material collected. Then the method provides for awarding fund certificates to the recycling consumer upon the accumulation of a sufficient point level.

### CROSS-REFERENCE TO RELATED APPLICATIONS

This application is a continuation application of U.S. application Ser. No. 11/542,880 filed Oct. 4, 2006 the disclosure of which is incorporated by reference herein in its entirety.

### BACKGROUND OF THE INVENTION

1. Field of the Invention

The invention relates to a method for promoting recycling from a fund established with revenue generated from the sale of certificates or other forms of program documentation attesting to the environmental and/or power generation attributes of an entity producing renewable electric energy. The method provides a point system by which a recycling consumer is credited for recycled materials collected. Further, the method provides a reward system for the redemption of points accumulated by the recycling consumer. The reward system's features include fund certificates that are drawn against the fund. The method includes collecting recyclable materials from the recycling consumer and crediting an account in the name of the recycling consumer based on the quantity and/or quality of the recyclable material collected. Further, the method awards fund certificates to the recycling consumer upon the accumulation of a sufficient point level.

2. Discussion of Background Information

One of the most significant threats facing the environment today results from human activity, causing the release of greenhouse gases to the atmosphere. Greenhouse gases, such as carbon dioxide, methane, nitrous oxide, water vapor, carbon monoxide, nitrogen oxide, nitrogen dioxide, and ozone absorb heat from incoming solar radiation but do not allow long-wave radiation to reflect back into space. Greenhouse gases in the atmosphere result in the trapping of absorbed heat and a warming of the earth's surface.

One example of how greenhouse gases are released into the atmosphere as a result of human activities is the release of carbon dioxide during the combustion of fossil fuels. This is evident in factories, utilities operating turbines to generate electricity, automobiles and other devices that combust fuel and release carbon dioxide gases into the atmosphere. Other human activities that result in releasing greenhouse gases to the atmosphere include wetland changes, destruction of forests, use of chlorofluorocarbons (CFCs) in refrigerator systems and use of CFCs and halons in fire suppression systems and various manufacturing processes. See http://experts.about.eom/e/g/gr/Greenhouse_gas.htm for more information. In addition, greenhouse gases can also be released by a more natural phenomenon, such as farming. For example, when farmers turn over the soil to work the land for growing crops, they inadvertently release carbon dioxide residing in the soil into the atmosphere. Other natural occurrences of releasing greenhouse gases to the atmosphere include, raising livestock, paddy rice farming, use of covered vented landfills, and fully vented septic systems that enhance the fermentation process. See “Farming Fight Global Warming with No-Till Farming”, by Kari Lydersen, AlterNet, Sept. 30, 2002, http://www.climateark.org/articles/reader.asp?linkid=16382.

As mentioned earlier, another example of greenhouse gases, released into the atmosphere by humans, is the release of nitrogen oxides. These gases are formed when fuel is burned at high temperatures, such as in a combustion process. See http://www.cogeneration.net/Global_Warming_Potential.htm. The primary sources of nitrogen oxides are motor vehicles, electric utilities, aircrafts, biomass burning and other industrial, commercial, and residential sources that result in burned fuels. See http://www.eurekalert.org/pub_releases/2001-04/AGU-Apce-1504101.php. Furthermore, nitrogen oxides, such as hydrocarbons are precursors to ozone formation. They also contribute to the formation of acid rain. As found by an EPA study and published in a report released in the spring of 1998, the nitrous oxide gases make up about 7.2 percent of the gases cited as contributing to global warming. See http://www.nutramed.com/environment/carsepa.htm. Currently, the EPA proposes regulations that are passed by the Congress to limit the release of nitrous oxide gases into the environment. See http://www.envirotools.org/factsheets/contaminants/nitrogenoxides.shtml#1ref. Some states, such as Connecticut, have taken an active role in reducing nitrogen oxides by introducing the 2005 Connecticut Climate Change Action Plan. The Governor's Committee on Climate Change prepared this plan, which makes specific recommendations to reduce non-CO₂ green house gases. See http://www.cqa.ct.qov/2006/rpt/2006-R-0290.htm.

In general, the effects of releasing greenhouse gases to the atmosphere caused by human activities have resulted in about a 30% increase in carbon dioxide concentration since the late 1800's. See http://www.rso.cornell.edu/qreens/kvotonow/gcc.html. Rising concentrations of CO2 and other greenhouse gases intensifies the Earth's natural greenhouse effects, and increases the risk of fundamental and costly changes to the earth's climate system. Global population growth projections and energy usage assumptions indicate that CO2 concentrations will continue to rise, likely reaching between two and three times its late-19th-century level by 2100. See http://www.usgcrp.gov/usgcrp/Library/nationalassessment/overviewclimate.htm. This dramatic doubling or tripling will occur over a 200-year period, a brief moment in geological history. The likely effects from rapid increases in concentrations of greenhouse gases to the Earth's atmosphere include more severe drought/precipitation cycles; longer and more extreme heat waves; an increase in the spread of tropical diseases; damage to vegetation and agricultural systems; and threats to seacoasts due to higher sea levels and storm surges. See http://www.cmd1.noaa.gov/infodata/fag cat-1.html and www.ci.keen.nh.us/planning/executivesummarykeenedraft.pdf.

The federal government has made significant strides over the years to support the renewable energy production market, and to reduce the harmful effects of greenhouse gases on Earth's atmosphere. Some examples include reducing the burning of fossil fuels, and reducing the country's dependency on the combustion of foreign fossil fuels for electric generation. The renewable power market includes so-called “green power” or “green energy” which can be defined as power production technologies that involve little or no pollution. For example, anaerobic digestion, geothermal power, wind power, small-scale hydropower, solar power, biomass power, tidal power and wave power fall under such a category. Some definitions of renewable or green power may also include power derived from the incineration of solid waste. See http://en.wikipedia.org/wiki/Green energy. In addition to requiring electric utilities to purchase power under certain conditions from certain renewable electric energy facilities in accordance with the Public Utility Regulatory Policies Act of 1978 (PURPA), in 1989 congress legislated research goals in the Renewable Energy and Energy Efficiency Technology Competitiveness Act. This act set federal funding levels for renewable technology and sought to achieve cost-competitive use of renewable technologies without the need for federal financial incentives. See www.epa.gov/conf/presentations/mccarron-508.pdf.

The federal government established a number of guidelines that helped create market incentives for the development of renewable energy. These incentives include federal financial and tax incentives for businesses, municipal entities, and not-for-profit organizations. Currently, some federal agencies offer special financing and mortgages to help finance the cost of renewable energy systems. In addition, owners or lessees of renewable energy facilities may be entitled to special depreciation rates and special treatment of taxes on bonds and leases. Some examples of these incentives include:
Production Tax Credit
Modified Accelerated Cost Recovery System (MACRS), e.g. Section 168(e)(3)(b) of the Internal Revenue Code, which provides specific depreciation for solar, wind, and geothermal facilities
Business Investment Tax Credit, e.g., 26 U.S.C.A. 48(a), which allows a deduction of up to 10% of the cost for investing in, purchasing, or constructing qualified energy production facilities for business use
Tax exemptions for grants and subsidies, e.g., some federal funded projects may be exempt from taxation
Federal funding sources, such as the U.S. Department of Energy and other federal agencies can issue Requests for Proposals (RFPs) and award funds for specific projects
Renewable energy production incentives, e.g., local and state government entities can apply for payment incentives from the Department of Energy for electricity produced and sold by new qualified renewable energy generation facilities.
   See http://www.mass.qov/doer/programs/renew/renew.htm#fedcred.

The concept of promoting the use of green renewable power to offset environmental impacts was fostered in the late 1990's, when the Environmental Protection Agency (EPA) regional headquarters in Seattle, Washington encountered a problem. A recent Presidential Order had encouraged federal agencies to buy electricity produced from renewable resources, but the region's utilities that served the agency's facilities were not offering “green power” to their customers. Therefore, the EPA chose one of its facilities (Manchester Marine Laboratory) and entered into an agreement with the Bonneville Environmental Foundation (BEF) to offset the environmental impacts of the Laboratory's electricity use by supporting a renewable energy project (i.e., wind energy). In doing so, the EPA became the first purchaser of “Green Tags”, and what the rest of the world now knows as environmental attributes. https://www.qreentaqsusa.orq/about/sitemap.shtm.

One of the policies enacted by state governments aimed at increasing the use of renewable energy in the electricity supply mix is the creation of Renewable Portfolio Standards (RPS) Programs. These programs are not voluntary but state government mandated policies in which the state sets a mandatory purchase level for the amount of renewables but does not set the price for the purchase of the renewable power. State RPS programs require retail power suppliers to obtain a predetermined percentage of the electricity they sell from renewable electric generating sources. Compliance with an RPS is demonstrated by the retail electrical supplier's acquisition of tradable “Renewable Energy Certificates” (RECs), or by the acquisition of generation from renewable electric energy production facilities. In essence, a REC represents the generation of one megawatt hour of energy by a renewable electric generating facility. See “The Clean Air Act Amendments of 1990: Opportunities for Promoting Renewable Energy,” Final Report, Dec. 11, 2000, by D. R. Wooley and E. M. Morse of Young, Sojmmer, Ward, Ritzenberg, Wooley, Baker & Moore, LLc, Albany, N.Y., pages 49-51. Furthermore, as discussed above, a renewable electric generating resource can be defined as natural energy resources that are inexhaustible, such as wind, solar energy, geothermal, biomass and hydropower. See http://www.awea.org/policv/rpsmechfed.html. However, for the purpose of qualifying for RPS benefits, “renewable energy” can be defined to include only those renewable resources that the particular state government wants to encourage. See http://www.harvestcleanenerqv.org/enews/enews 0505/enews 0505 Recycling Wood Chips.htm. Further, the RECs trading system is modeled after the sulfur dioxide (SO₂) credit-trading program under the federal Clean Air Act and the emission-reduction credit-trading program of the South Coast Air Quality Management District's Regional Clean Air Incentives Market (RECLAIM) Program in Southern California. Similar automated markets have been developed under the RPS's credit trading system. See http://www.awea.org/policy/rpsmechfed.html. Further still, within a RECs trading system, each certificate (REC) carries information such as air emission data, the type of fuel used to generate the electricity, where the power was generated, and the generation year or “vintage.” Power markets with tracking systems monitor the attributes of each power plant in the region.

As discussed above, the basic framework of an RPS program involves states establishing standards, which require those entities providing power supply to end use consumers to provide a certain percentage of their power supply (measured in megawatt-hours) from renewable energy sources. For example, if a state has an RPS requirement of 5% for a certain year, a power supplier that sells 1,000,000 megawatt-hours of power that year to in-state end use consumers will need to obtain 50,000 megawatt-hours of the power it sells, from renewable energy sources or have purchased 50,000 RECs in the REC trading market. Note that the REC is distinct from the underlying electricity itself. The underlying megawatt-hour that gave rise to the REC, can be “bundled” and sold with the REC or each can be separately sold. RECs are tradable intangible property that represents the environmental and/or power generation attributes of a unit of renewable energy. Also as discussed above, under most state RPS programs, one renewable energy certificate represents the environmental and/or power generation attributes associated with the actual generation of one megawatt-hour of electricity from a renewable electric generation source. Therefore, RECs verify that a specific amount of renewable electric energy actually has been produced. Hence, retail power suppliers, in attempting to meet the RPS requirements, can: (i) produce renewable electric energy themselves to obtain the amount of renewable power they need, (ii) buy renewable electric energy from another producer, or (iii) purchase the appropriate number of RECs in the REC trading market. The REC system provides compliance flexibility for the retail power suppliers and avoids the need to “track renewable power electrons and attributes”. To keep track of the creation and trading of RECs a certifying agency gives each REC a unique identification number. Once a REC is so identified, the generation attributes associated with the REC (such as those attributes that make a REC eligible for use in any particular state's RPS program) are also identified in the regional data base tracking systems. These data base tracking systems include the: Western Renewable Energy Generation Information System (WREGIS), New England Power Pool (NEPOOL), Generation Attributes Tracking System (GATS), Electric Reliability Council of Texas (ERCOT) and Midwest Renewable Energy Tracking System (M-RETS). The trading of RECs within any particular state RPS is done through markets made by brokers or in private transactions between the buyer and seller. The above noted data bases inform the market participants of the eligibility of RECs for a particular state RPS and keep track of ownership of the REC.

Since the late 1990's, RECs and green power tags have become an effective method of increasing renewable electric energy generation markets from the perspective of both producers and consumers of renewable energy. For producers, selling RECs or green power tags generates a second revenue stream in addition to the income they earn from selling commodity electricity at market or contract rates. This additional revenue helps make renewable electric energy more cost-competitive with conventional electric power and stimulates the development of more new renewable electric energy projects. RECs enable power suppliers to sell their power output where it can be easily delivered to the power grid and its renewable attributes (RECs) in other markets where they may bring higher value. For state policy makers, RECs allow the state's citizens as a whole to support renewable power and cleaner air emissions. For consumers, green power tags make it possible to support renewable energy generated from many types of fuels in favorable locations, and to separate investments in renewable energy from their electric power purchases, thus avoiding the need to switch power providers to support renewable power generation technologies.

Renewable power trading systems operate in two types of markets, voluntary markets for green power tags and regulatory compliance markets for RECs. Voluntary markets comprise of voluntary purchasers, e.g., companies, government agencies, nonprofit institutions, or households, that buy green power tags from sources of their choice for purposes such as supporting renewable energy development, meeting corporate environmental performance pledges, or stimulating local economic development (if the credit comes from a nearby energy source). For example, homeowners who do not have access to green pricing options in their state can support renewable energy by buying green power tags representing renewable energy generated elsewhere, and companies that want to support local communities can buy them from nearby generators. See http://www.enerqybulletin.net/3784.html.

As discussed above, many states have enacted RPS programs. RPS requirements vary widely from state to state. For example, some RPS requirements can be met only with power generated within the regional power pool (i.e., the set of interconnected electric grids and power plants that are collectively operated to serve the region's demand for power), while other states mandate that the renewable energy must be generated within their own territories. States may require a certain fraction of renewable power to be generated from facilities constructed after adoption of the RPS requirement, rather than from existing renewable generators, in order to stimulate additional development of renewable resources. Some states separate renewable fuels into tiers and require a minimum amount of energy to be produced from preferred fuels and technologies. At present there is no federal RPS. If a national RPS is enacted at some point; it could lead to the creation of a national REC trading program. See http://www.enerqybulletin.net/3784.html

In most regulatory compliance markets, especially where states have adopted highly specific RPS requirements, a limited supply of RECs exists to meet REC buyers' needs. Therefore, prices for these RECs tend to be higher than the price of green power sold in voluntary markets. According to data from the brokerage service Evolution Markets, in 2004 RECs in an RPS program were selling for about $14 in Texas and for $50 in Massachusetts. In contrast, voluntary green power generated in a number of states (effective for years 2003 through 2010) are being offered at prices between $0.75 and $5.00, with a few wind green power tags priced at about $15 and one California solar REC offered at $50. See http://www.enerqybulletin.net/3784.html.

As of March 2006, RPS programs have been adopted in 21 states. In addition, the U.S. Congress is considering passing legislation for a national RPS. Internationally, many European countries have adapted RPS or green power programs and in the near future, renewable power and green power environmental attributes may be traded on the world market. Accordingly, United States projections for state renewable electricity standards, laws and regulations for RPS's will support nearly 31,100 megawatts (MW) of new renewable power by 2017; this is an increase of 230 percent over the total 1997 U.S. levels (excluding hydro). This projection of new renewable power represents enough clean power to meet the electricity needs of 20.3 million typical homes. The standards in California, Texas, New York, New Jersey, and Pennsylvania create the five largest markets for new renewable energy growth. By 2017, annual new renewable energy production from all state RPS programs will reduce carbon dioxide emissions, (the heat-trapping gas primarily responsible for global warming) by nearly 75 million metric tons (MMT). This level of reductions is equivalent to removing 11.1 million cars off the road or planting more than 17.9 million acres of trees—an area larger than the state of West Virginia. See http://www.ucsusa.org/clean energy/clean energy policies/res-at-work-in-the-states.html.

Accordingly, these states are proving that renewable portfolio standards are an affordable solution for reducing CO2 and other unhealthy air emissions. In addition, these standards result in alleviating the harmful impact that fossil fuel extraction, transport, and use have on the land and water resources. In fact, if a national RPS policy mandated a 20% renewable standard, America would increase its total renewable power to 180,000 MW by 2020; this is nearly 11 times more than the current levels. Furthermore, the 20 percent national standard would reduce the projected growth in power plant CO2 emissions under a business-as-usual scenario by more than half, or 434 MMT per year by 2020. This level of reductions is equivalent to removing nearly 65 million cars off the road or planting 104 million acres of trees, an area approximately the size of Oregon and Washington combined. Even a 10 percent standard would result in substantial climate benefits, reducing the annual CO2 emissions by 166 MMT, by 2020. See http://www.ucsusa.org/clean energy/clean energy policies/RES-climate-strateqy.html.

However, there are many barriers to developing renewable energy sources in United States and around the world. Renewable resources compete against mature fossil fuel and nuclear technologies, and they must overcome two major roadblocks to commercialization: undeveloped infrastructure and lack of economies of scale. First, developing an infrastructure for new renewable resources will require large initial investments. These investments will increase the cost of providing renewable electricity, especially during the early years. Examples of these investments may include: 1) prospecting, finding publicly acceptable sites with good resources and with access to transmission lines; 2) permitting issues, renewable energy sources often involve new issues and ecosystem impacts, such that standards are still being developed; and 3) Marketing, communicating the benefits of renewable energy resources to customers in order to persuade them to switch from traditional sources; 4) Installation, operation, and maintenance for starting up new renewable energy facilities. In addition, there are many barriers to developing renewable energy sources, which relate to promoting RECs. These include the need for an accurate and verifiable generation data, a credible mechanism for issuing certificates, a method for tracking certificate ownership, better understanding of what a certificate represents, lack of market liquidity, and a method of protecting against double-counting. These barriers constitute significant transaction costs and impede the progress of adopting renewable energy source commitments that can lead to the reduction of greenhouse gases. See http://www.ucsusa.org/clean energy/renewable energy basics/barriers-to-renewable-energy-technologies.html.

Thus, an improved renewable energy trading system is needed, to realize greenhouse gas reduction objectives by awarding environmental attributes as an incentive to improve the environment. Furthermore, there is a need for an organized trading system that will encourage consumers to recycle. Finally, there is a demand for a standards-based, organized trading market for recycling.

### SUMMARY OF THE INVENTION

The present invention is directed to promoting recycling by establishing a fund using revenue generated from the sale of environmental and/or power generation attributes by an entity that produces renewable energy. The method provides a point system, which credits an account assigned to the recycling consumer for collected recycled materials. The method includes a reward system for the recycling consumers to redeem points accumulated by their recycling; the reward system includes redeemable fund certificates, which can be drawn against the fund. The method includes collecting recyclable materials from the recycling consumers and crediting their account based on the quantity and/or quality of the recyclable material collected. Recycling consumers receive award fund certificates upon accumulating sufficient number of points.

According to an aspect of the invention, the fund certificates can be created when the entity producing renewable energy generates electricity. Further, the entity producing renewable energy may capture energy from a natural process or phenomenon selected from a group consisting of sunshine, wind, wave power, flowing water, tidal energy, biomass, biomass-based waste products and geothermal heat flow. Further still, the entity producing renewable energy may capture energy from biomass for the production of bio-diesel, ethanol and/or methanol. It is possible, the entity producing renewable energy can be a biomass facility that generates electricity through the burning of methane gas produced in a landfill to power a generator.

According to an aspect of the invention, the fund certificates can be created when a entity producing energy generates electricity from one or more resource that may be defined by a government policy process as a government labeled renewable resource. For example, the government labeled renewable resource may include forest biomass and/or wood.

An aspect of present invention may further provide a point system having a weight-based system and/or a volume-based system or some combination thereof. It is possible the point system may include a quality rating system with a weight-based system and a volume-based system or some combination thereof. Further, the point system may include a point tier system having one or more tier levels that are based on the quantity and quality of recycled materials collected by each recycling consumer for a specific periodic period.

According to an aspect of the invention, the fund certificates may be redeemable as a credit to a bill from a power supplier. Further, the fund certificates can be redeemable as a coupon for use in the purchase of goods or services. Further still, the fund certificates may be deliverable to the recycling consumer through a recycling consumer account. It is possible the fund certificates can be deliverable via an email address associated with the recycling consumer. Further still, the fund certificates may be directly deposited on a key fob and/or a magnetic swipe card associated with the recycling consumer. The fund certificates may be directly deposited on one of a debt card, a credit card and a bank account associated with the recycling consumer. Further, the fund certificates can be a coupon and/or a rebate in a third party service.

According to another embodiment of the present invention, the invention can be directed to a system for promoting recycling from fund certificates drawn against a fund established with revenue generated from selling environmental and/or power generation attributes by a entity producing renewable energy. Further, the system comprises a registry that stores redeemable point information for collected recyclable material from participants in a recycling program, and fund certificate data in a reward program. The system further comprises a transfer platform communicatively coupled to the registry, the transfer platform being configured to enable the redemption of accumulated points in the recycling program for fund certificates in the reward program.

According to an aspect of the present invention, the system includes at least one fund certificate that can be created when the entity producing renewable energy generates electricity. Further, the system may include an entity producing renewable energy that is selected from a group consisting of solar power, wind, geothermai, biomass, hydropower, hydrogen fuel and non-conventional energy producing technologies. Further still, the system may include an entity producing renewable energy that is a biomass entity, which can be selected from a group consisting of bio-diesel, ethanol and methanol. The entity producing renewable energy that is a biomass entity may generate electricity through the burning of methane gas produced in a landfill to power a generator.

According to another embodiment of the present invention, the invention can be directed to a computer-based system for facilitating the trade of points and fund certificates such that the fund certificates are established with revenue generated from the sale of environmental and/or power generation attributes by an entity producing renewable energy. The method comprises the means for establishing a rewards system for the redemption of points accumulated by a recycling consumer, such that the points are credited to the recycling consumer for recycled materials collected. The method further comprises the means for determining credits of points for each recycling consumer in order to award fund certificates to the recycling consumer upon the accumulation of a sufficient point level.

According to another embodiment of the present invention, the invention can be directed to a method of increasing recycling of materials by creating a demand for tradable fund certificate, such that the fund certificate is established with revenue generated from the sale of environmental attributes and/or power generation by an entity producing renewable energy. The method comprises providing recycling consumer point data based on recycling materials and associated with points. The method further comprises applying a factor for converting the recycling consumer point data to the fund certificate, in which the factor is based on the amount of points credited to compute the fund certificate. Then, the method includes computing the fund certificate for the recycling consumer based on points credited for recycled materials collected. Finally, the method comprises enabling the recycling consumer to acquire the fund certificate in an amount that is at least equivalent to the computed fund certificate so as to increase the recycling of materials.

According to an aspect of the present invention, it is likely a federally mandated national RPS policy can benefit the invention by increasing participation and awareness of renewable resources. The effects of the above-mentioned benefits will likely lead recycling consumers to want to recycle more which will further promote the development of renewable resources. For example, a national RPS policy can provide uniform pricing and increase the market liquidity for buying and selling RECs. In addition, a national RPS policy can help overcome the two major roadblocks to the commercialization of renewable resources, which as mentioned earlier are lack of developed infrastructures, and economies of scale. As discussed earlier, some benefits resulting from an established RECs infrastructure, may include generation of accurate and verifiable data, a credible mechanism for issuing certificates, a method for tracking certificate ownership, better understanding of what a certificate represents, and a method of protecting against double-counting. As a result, renewable resources will most likely compete against mature fossil fuel and nuclear technologies markets in the future.

Other exemplary embodiments and advantages of the present invention may be ascertained by reviewing the present disclosure and the accompanying drawing.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention is directed to a method for promoting recycling from a fund established with revenue generated from the sale of environmental and/or power generation attributes by an entity producing renewable energy. The method comprises providing a point system by which a recycling consumer is credited for recycled materials collected. Further, the method provides for a reward system for redemption of points accumulated by the recycling consumer, the reward system including redeemable fund certificates drawn against the fund. The method further includes collecting recyclable materials from the recycling consumer and crediting an account in the name of the recycling consumer based on the quantity and/or quality of the recyclable material collected. Then the method provides for awarding fund certificates to the recycling consumer upon the accumulation of a sufficient point level.

According to one aspect of the invention, the method includes the promotion of recycling with the help of a fund established with revenue generated from the sale of environmental and/or power generation attributes by an entity that produces renewable energy. An entity producing renewable energy can include a non-commercial entity (e.g., a co-op, or a group of individuals), a commercial entity (i.e., a corporation, partnership, Limited Partnership (LP), Limited Liability Partnership (LLP), Limited Liability Company (LLC), Limited Company (Ltd.), a non-profit organization, a sole proprietorship, and/or a trust company), a government entity, or any combination thereof that produces energy from a renewable resource. Renewable energy technologies can include technologies that rely on energy derived directly from the sun, wave or tidal energy, hydroelectric, wind, geothermal, biomass, or biomass-based waste products (including landfill gases). The renewable energy can be based on any technology that relies primarily on an energy source that is naturally regenerated over a period of time and is derived directly or indirectly from the sun, fuel cells, moving water, or any other natural movements and mechanisms of the environment. However, it is possible that for the purpose of generating fund revenues from the sale of environmental and/or power generation attributes, that the present method may include all technologies deemed eligible renewable energy according to various state Renewable Portfolio Standards (RPS) programs. The term “renewable energy” can be expanded to include those renewable resources that a particular state government would like to encourage. For the purposes of the present invention, solar power can be defined as a technology that obtains usable energy from the sun's light. In addition, moving water can be defined as energy that is extracted from moving or falling water. Examples of water power may include waterwheels, hydroelectric energy generators (or hydroelectric dams), tidal power (e.g., captures energy from tides in a horizontal direction), tidal stream power (e.g., captures energy from tides in a vertical direction), and wave power (e.g., uses the energy in waves). Furthermore, wind energy (or wind power) production can be defined as the conversion of wind energy. One example of how this energy conversion can be accomplished is by using wind turbines to generate electricity by converting the rotation of turbine blades into electrical current via an electrical generator. Based on the present invention, geothermal power (or geothermal energy) production can be defined as the use of geothermal heat to generate electricity. By non-limiting example, geothermal energy may be produced by harnessing the Earth's natural geological heat sources and converting it to a source that can heat an occupied property. In addition, the term biomass may be defined as relating to energy production referring to living and recently living biological material that can be used as fuel. Biomass may also be referred to as plant matter grown to be used as biofuel, but can also include plant, wood or animal matter used for production of heat. Furthermore, biofuels may include any fuel that is derived from biomass, including recently living organisms or their metabolic byproducts, such as cow manure. It is possible to further define biomass to include biofuels that may include vegetable oil, biodiesel, and butanol ethanol (including ethanol fuel mixtures). Also, fuel cells can be defined as an electrochemical energy conversion device. By non-limiting example, reactants that can be used in a fuel cell may be hydrogen on the anode side and oxygen on the cathode side (a hydrogen cell), such that typically reactants flow in and reaction products flow out.

According to one aspect of the invention, the method involves promoting recycling by using a fund established with revenue generated from the sale of environmental and/or power generation attributes. The phrase “environmental and/or power generation attributes” may also be referred to as, Renewable Energy Credits or Certificates (RECs), Green Tags, and Tradable Renewable Certificates (T-RECs or TRCs). Environmental and/or power generation attributes can be described as the embodiment of all attributes of renewable energy generation as an instrument that can be bought and sold and that conveys a contractual right to combine those attributes (a certificate). By non-limiting example, one REC can be regarded as a tradable certificate of proof that one megawatt-hour of electricity has been generated by a renewable fuel source. In other words, a REC can be created only when the associated renewable energy resource generates one unit (measured in MWhs) of electricity.

According to one aspect of the invention, the method involves a fund that can be used to promote recycling, such that the fund is established with revenue generated from the sale of environmental and/or power generation attributes by an entity producing renewable energy. In particular, the fund is created from selling RECs. In addition to the income for the entity producing renewable energy from the sale of the power itself (the mega-watts and the mega-watt hours), selling RECs generates a second source of revenue. This additional revenue can be used for setting-up a fund that can be used as a reward; for example, recycling consumers can receive redeemable fund certificates for their recycled materials.

A recycling consumer may include a non-commercial resident (e.g., individuals, households, and/or a person or group with a budget which can be spent on a range of goods and services available on the market), commercial resident (e.g., a corporation, partnership, Limited Partnership (LP), Limited Liability Partnership (LLP), Limited Liability Company (LLC), Limited Company (Ltd.), non-profit corporation, sole proprietorship, and/or trust company), and/or any combination thereof that recycles materials. Furthermore, a recycling consumer may include recycling consortiums consisting of residents of apartment buildings, schools and other common facilities, and government users including local, state, and federal government entities.

To track recycling activity, each consumer will have a recycling consumer account assigned to them. The recycling consumer account provides information about the consumer and the consumer's activities. For example, the recycling consumer account may include such information as name, address, and home telephone number, alternate contact information (e.g., related family, living partners, etc.), and work address and telephone number. It is possible that the recycling consumer account may include information about the recycled materials collected for each recycling consumer, in terms of quality, amount and type of recycled material. As will be discussed below, the recycling consumer account can include information regarding all aspects of the recycled materials collected for each recycling consumer.

According to the present invention, the process of recycling materials may be described as the reprocessing of used materials that would otherwise become waste in order to break them down and remake them into new products. Recycled materials may include but are not limited to glass, paper, aluminium, steel, textiles, and plastic. Furthermore, these materials can be derived either from pre-consumer waste (materials used in manufacturing) or post-consumer waste (materials discarded by the consumer).

According to another aspect of the invention, the method involves providing a point system by which a recycling consumer is credited for their recycled materials. Generally, the point system is structured based on collecting recyclable materials from the recycling consumer and crediting their account according to the quantity and/or quality of their recyclable materials. In addition, the method provides a system for awarding fund certificates to the recycling consumer upon the accumulation of sufficient point level. In particular, the point system can include a weight-based, a volume-based, and/or some combination of weight and volume-based system for determining the amount of points to be credited to the recycling consumer's account. For example, the weight-based system can provide a process for weighing the recycled materials collected from the recycling consumer and crediting their account with a number of points based on a specific weight of recycled materials collected. On the other hand, the volume-based system may provide a process for verifying the volume of recycled materials collected from the recycled consumer and crediting their account with a number of points based on a specific volume of recycled materials collected. It is possible that the above systems (weight-based and volume-based) require the recycling consumers to use standard sizes or supplied containers and/or to allow the recycling consumers to use their own containers. Furthermore, the present method may determine the point structure based on the type and size of containers used for the recycled materials. By non-limiting example (under the above-mentioned weight-based and volume-based systems), recycling consumers can be provided with containers (large cans with a capacity of 64-96 gallons or small or variable cans with a capacity of 32-64 gallons), wherein a different point-rate can be credited for different size containers. Furthermore, the point system can include a weight-based, and/or volume-based, and/or some combination thereof and according to the quality of recycled materials collected. For example, the present method may determine an amount of points to be credited to the recycling consumer's account based on first determining the weight and/or volume, then making a determination on the quality of the recycled materials collected. If the recycled materials received meet the specific weight and/or volume requirement for being awarded a certain amount of points, but the quality of the recycled materials are not satisfactory, then the recycling consumer may receive fewer points to be credited to their account. On the contrary, it is possible in the above example, for the recycling consumer to be credited more points for the same specific weight and/or volume of recycled materials, if the quality of the recycled material received is more than satisfactory. As will be discussed below, the point system may be structured such that the recycling consumer may be awarded more or less points to their account depending on the amount of recycled materials collected over a specific period of time.

According to an aspect of the invention, the method provides for a reward system for the redemption of points accumulated by the recycling consumer, such that the reward system includes redeemable fund certificates drawn against the fund. The method further includes awarding fund certificates to the recycling consumer upon the accumulation of a sufficient point level. In particular, the recycling consumer after receiving the awarded fund certificates may redeem the fund certificates at their local power supplier for a credit to their power bill. However, it is also possible the recycling consumer upon receiving the awarded fund certificates may request the entity that provides the fund certificates to submit the redeemable fund certificates to the recycling consumer's local power supplier for a credit to their power bill.

It is possible the recycling consumer may be able to redeem the fund certificates either after and/or before crediting their power bill for an economic benefit such as a coupon for anyone of the following: the discount of goods and/or services provided by third parties, a discount on a municipal related expense and a subscription program. For example, the advantage to the recycling consumer for redeeming the fund certificate for the economic benefit may include a gift certificate and/or credit usable by the recycling consumer for any one of the above-mentioned benefits. Further, the economic benefit to the recycling consumer may include an item of commercial value, a reward (designated in any form), or discounts to pricing on collection service, or any other transferable item that is of value to the recycling consumer, commercial recycling consumer, government recycling consumer or consortium of recycling consumers. In particular, the item of commercial value (a coupon or reward) usable by a recycling consumer in the purchase of consumer or business goods, such as those found in retail stores such as household goods, grocery markets, and the like. The item of commercial value can be deposited in the recycling consumer account that could include an electronic coupon or rebate. Alternatively, for those recycling consumer in rural settings, the item of commercial value may be directly deposited on the key fob or magnetic swipe card that the recycling consumer uses for identification during the collection process. In such an instance, the item of commercial value may include a monetary credit directly applied to a magnetic swipe card, such as for example a credit or debit card commonly available and used frequently in commerce. Likewise, for other recycling consumers, the item of commercial value may be a monetary credit directly applied to the recycling consumer account, which may be associated with a debit card, credit card, or bank account associated with the user account for purposes of paying for third party services. Alternatively, the item of commercial value may be a coupon or discount to be used for specific consumer or business products made by specified manufacturers and sold by specified retailers, wherein those products are commonly recycled. Lastly, a user consortium may be interested in benefits that can be readily divided among a group, such as coupons, rebates or rate reductions in a third party service. For reference relating to a more general reward system see U.S. patent application Ser. No. 11/387,076 filed Mar. 20, 2006 by John W. Casella et al., titled “System and Methods for A Recycling Program.”

It is possible the recycling consumer may redeem the fund certificates for environmental and/or power generation attributes and/or RECs that can be purchased on the relevant markets.

According to another aspect of the invention, the method may further provide information regarding the recycling consumer account relating to all aspects of the recycled materials collected for each recycling consumer. For example, the recycling consumer's account may include information such as the different types of recycled materials collected from each recycling consumer. Furthermore, the recycling consumer's account may include information regarding the type of waste collection services used by a recycling hauler to collect the recycled materials. These could include curbside pick-up, mobile household hazardous waste collections, household hazardous waste drop-off facilities, transport recycling drop-off centers, and landfills. In addition, the recycling consumer's account may include information such as the type of recycled materials collected by category. Some examples of categories of recycled materials include solid waste, bulky waste, white goods, yard waste, electronic waste, other non-commercial entity waste, and other commercial waste. It is possible that the recycling consumer's account can include information relating to a geographic location, weight, volume, and the pick up time and date for the recycled materials collected from each recycling consumer. Furthermore, the recycling consumer's account may include information relating to the recycling consumer's history with respect to the recycled materials collected, possibly from years past. It is also possible that the recycling consumer's account can include information relating to an estimation of an amount of recycled materials to be collected in the future over a specific period of time. The advantage of estimating the recycling consumer's potential for providing recycled materials in the future, may be useful in spurring an economic benefit for the local economy.

This benefit could be in the form of corporate growth, which would increase jobs as well as putting money back into the community. For example, the above-mentioned method may provide information that could help an entity, such as a manufacturing facility to determine profitability (or lack of profitability) by estimating the potential of the recycling consumer's community that utilizes the by-products or the recycled materials collected.

According to another part of the invention, the present method may provide the recycling consumers with access to their accounts through a computer network. When they access their account, the recycling consumers can view their account information and find out if they have accumulated any award certificates. The present method allows a recycling consumer to directly utilize the fund certificate provided herein. This process might entail downloading and printing a coupon, paying a portion of the power bill with collected points. It is possible that the recycling consumer's account may be communicating (possibly via the computer network mentioned above) with a transmitting group consisting of: email, telephone, text message, paper mail, fax, Internet, or any type of electronic medium used to provide account information and/or access for the recycling consumer.

According to another part of the invention, the present method may include a point system based on a tier system. For example, the point system may include one or more tier levels that may be based on the quantity and quality of the recycled materials collected from each recycling consumer during a specific period of time. By non-limiting example, each tier may require a specific quantity and quality of recycled materials collected from each recycling consumer during a specific period of time. This will allow the recycling consumer to receive extra points in addition to the standard allotted points received for the quantity and quality of recycled materials collected. For example, the multi-tier point system can be set up such that when the quantity and quality of recycled materials collected increases for each tier, so does the amount of extra points in addition to the standard allotted points received for the quantity and quality of recycled materials collected. The advantage to establishing a multi-tier system may be two-fold: first, the recycling consumer is provided with even more incentives to recycle in order to collect points and obtain more fund certificates; and secondly, the environment will improve since less recyclable materials will reach the landfill. In addition, fewer raw materials will be used for manufacturing goods since more recyclable materials will be available. Furthermore, the multi-tier point system may provide increased incentives for recycling consumers. One example is manufacturing facilities striving to reduce their operating costs, e.g., power to run machinery, by receiving fund certificates. It is not uncommon for some manufacturing facilities to spend more than 50% of their operating costs on power alone.

According to another part of the invention, the present method may include a “report” on the recycling consumers' activities over a specific period of time. By non-limiting example, the report mentioned above may include a summation of the recycled materials collected by the recycling consumers as they relate to information such as: points collected, fund certificates awarded, and fund certificates redeemed over a specific period of time. In addition, the report may be communicating with a transmitting medium group consisting of one of: email, telephone, text message, paper mail, fax, Internet and any other electronic medium, in order to provide account information to the recycling consumer. It is possible that the above transmitting medium could be transmitted in real time, such that the recycling consumer can monitor their recycling account activities in real time.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for promoting recycling from a fund established with revenue generated from the sale of environmental and/or power generation attributes by an entity producing renewable energy, the method comprising:
a) providing a point system by which a recycling consumer is credited for recycled materials collected;
b) providing a reward system for redemption of points accumulated by the recycling consumer, the reward system including redeemable fund certificates drawn against the fund;
c) collecting recyclable materials from the recycling consumer and crediting an account in the name of the recycling consumer based on the quantity and/or quality of the recyclable material collected; and
d) awarding fund certificates to the recycling consumer upon the accumulation of a sufficient point level.

2. The method of claim 1, wherein the fund certificates are created when the entity
producing renewable energy generates electricity.

3. The method of claim 1, wherein the entity producing renewable energy captures energy from a natural process or phenomenon selected from a group consisting of sunshine, wind, wave power, flowing water, tidal energy, biomass, biomass-based waste products and geothermal heat flow.

4. The method of claim 1, wherein the entity producing renewable energy captures energy from biomass for the production of one of bio-diesel, ethanol and methanol.

5. The method of claim 1, wherein the entity producing renewable energy is a biomass facility that generates electricity through the burning of methane gas produced in a landfill to power a generator.

6. The method of claim 1, wherein the fund certificates are created when a entity producing energy generates electricity from one or more resource that is defined by a government policy process as a government labeled renewable resource.

7. The method of claim 6, wherein the government labeled renewable resource includes one of forest biomass and wood.

8. The method of claim 1, wherein the point system includes one of a weight-based system and a volume-based system or some combination thereof

9. The method of claim 1, wherein the point system includes a quality rating system with one of a weight-based system, a volume-based system or some combination thereof.

10. The method of claim 1, wherein the point system includes a point tier system including one or more tier levels that are based on the quantity and quality of recycled materials collected by each recycling consumer for a specific periodic period.

11. The method of claim 1, wherein the fund certificates are redeemable as a credit to a bill from a power supplier.

12. The method of claim 1, wherein the fund certificates are redeemable as a coupon for use in the purchase of goods or services.

13. The method of claim 1, wherein the fund certificates are deliverable to the recycling consumer through a recycling consumer account.

14. The method of claim 1, wherein the fund certificates are deliverable via an email address associated with the recycling consumer.

15. The method of claim 1, wherein the fund certificates are directly deposited on one of a key fob and magnetic swipe card associated with the recycling consumer.

16. The method of claim 1, wherein the fund certificates are directly deposited on one of a debt card, a credit card and a bank account associated with the recycling consumer.

17. The method of claim 1, wherein the fund certificates are one of a coupon, a rebate in a third party service.

18. A system for promoting recycling from fund certificates drawn against a fund established with revenue generated from selling environmental and/or power generation attributes by a entity producing renewable energy, the system comprising:
a) a registry that stores redeemable point information for collected recyclable material from participants in a recycling program, and fund certificate data in a reward program; and
b) a transfer platform communicatively coupled to the registry, the transfer platform being configured to enable the redemption of accumulated points in the recycling program for fund certificates in the reward program.

19. The system of claim 18, wherein the fund certificate is created when the entity producing renewable energy generates electricity.

20. The system of claim 18, wherein the entity producing renewable energy is selected from a group consisting of solar power, wind, geothermal, biomass, hydropower, hydrogen fuel and non-conventional energy producing technologies.

21. The system of claim 20, wherein the biomass is selected from a group consisting of bio-diesel, ethanol and methanol.

22. The system of claim 18, wherein the entity producing renewable energy is a biomass entity that generates electricity through the burning of methane gas produced in a landfill to power a generator.

23. A computer-based system for facilitating the trade of points and fund certificates such that the fund certificates are established with revenue generated from the sale of environmental and/or power generation attributes by an entity producing renewable energy, the method comprises:
a) means for establishing a rewards system for the redemption of points accumulated by a recycling consumer, such that the points are credited to the recycling consumer for recycled materials collected;
b) means for determining credits of points for each recycling consumer in order to award fund certificates to the recycling consumer upon the accumulation of a sufficient point level.

24. A method of increasing recycling of materials by creating a demand for tradable fund certificate, such that the fund certificate is established with revenue generated from the sale of environmental attributes and/or power generation by an entity producing renewable energy, the method comprises:
a) providing recycling consumer point data based on recycling materials and associated with points;
b) applying a factor for converting the recycling consumer point data to the fund certificate, in which the factor is based on the amount of points credited to compute the fund certificate;
c) computing the fund certificate for the recycling consumer based on points credited for recycled materials collected;
d) enabling the recycling consumer to acquire the fund certificate in an amount that is at least equivalent to the computed fund certificate so as to increase the recycling of materials.
